(19) United States
(12) Patent Application Publication
(10) Pub. No.: US 2015/0016004 A1
(43) Pub. Date: Jan. 15, 2015

(54) OVER-CURRENT PROTECTION CIRCUIT

(71) Applicants: HONG FU JIN PRECISION INDUSTRY (ShenZhen) CO., LTD., Shenzhen (CN); HON HAI PRECISION INDUSTRY CO., LTD., New Taipei (TW)

(72) Inventor: HAI-QING ZHOU, Shenzhen (CN)

(21) Appl. No.: 14/324,847

(22) Filed: Jul. 7, 2014

(30) Foreign Application Priority Data
Jul. 10, 2013 (CN) 2013102870921

(51) Int. Cl. H02H 3/08

(52) U.S. Cl. CPC H02H 3/08
USPC 361/93.1

(57) ABSTRACT

A circuit protecting the components of a power circuit against passing an over-current is connected to an enable terminal of a pulse width modulation (PWM) controller of a power supply circuit on a motherboard, protecting the field effect transistors (FETs) of a first power circuit of the power supply circuit. The protecting circuit includes a first protection circuit. When a current of the first power circuit is increased, the temperatures of the FETs of the first power circuit also increase. The first protection circuit then outputs a low-level signal to the enable terminal of the PWM controller and the PWM controller stops operation thereby protecting the FETs of the first power circuit.

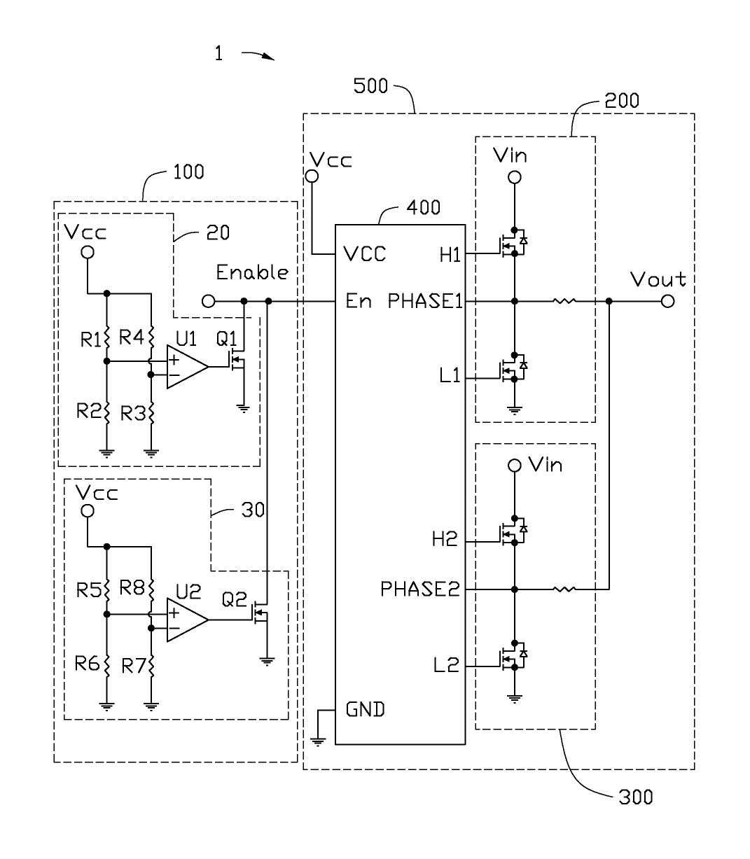

### FIELD

The present disclosure relates to an over-current protection circuit of a computer.

### BACKGROUND

Many power circuits are arranged on a motherboard of a computer for providing voltages and currents to a CPU. An over-current protection circuit protects the CPU, but when one power circuit overproduces, and when the current protection current has not initialized, then field effect transistors (FETs) in the power circuit can be damaged.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the presented embodiments.

The FIGURE is a circuit diagram of an embodiment of an over-current protection.

### DETAILED DESCRIPTION

The disclosure, including the figure, is illustrated by way of example and not by way of limitation. References to “an” or “one” embodiment in this disclosure are not necessarily to the same embodiment, and such references mean “at least one”. Although disclosure herein is directed to a computer, it will be understood that the principles described can be utilized with other electronic devices.

The FIGURE shows an embodiment of an over-current protection circuit 100 connected to a power supply circuit 500 on a motherboard 1. In the embodiment, the power supply circuit 500 can comprise a pulse width modulation (PWM) controller 400, a first power circuit 200 connected to a first output terminal of the PWM controller 400, and a second power circuit 300 connected to a second output terminal of the PWM controller 400. When an enable terminal En of the PWM controller 400 receives a high-level signal, the first power circuit 200 and the second power circuit 300 can both operate to provide a stable voltage Vout.

Corresponding to the first power circuit 200 and the second power circuit 300 in the power supply circuit 500, the over-current protection circuit 100 can comprise a first protection circuit 20 for protecting the first power circuit 200 and a second protection circuit 30 for protecting the second power circuit 300. The first protection circuit 20 comprises a comparator U1, an electronic switch Q1, and resistors R1-R4. A non-inverting input terminal of the comparator U1 is connected to a power source Vcc through the resistor R1. The non-inverting input terminal of the comparator U1 is grounded through the resistor R2. An inverting input terminal of the comparator U1 is connected to the power source Vcc through the resistor R4. The inverting input terminal of the comparator U1 is grounded through the resistor R3. An output terminal of the comparator U1 is connected to a first terminal of the electronic switch Q1. A second terminal of the electronic switch Q1 is connected to the enable terminal En of the PWM controller 400. A third terminal of the electronic switch Q1 is grounded.

The second protection circuit 30 comprises a comparator U2, an electronic switch Q2, and resistors R5-R8. A non-inverting input terminal of the comparator U2 is connected to the power source Vcc through the resistor R5. The non-inverting input terminal of the comparator U2 is grounded through the resistor R6. An inverting input terminal of the comparator U2 is connected to the power source Vcc through the resistor R8. The inverting input terminal of the comparator U2 is grounded through the resistor R7. An output terminal of the comparator U2 is connected to a first terminal of the electronic switch Q2. A second terminal of the electronic switch Q2 is connected to the enable terminal En of the PWM controller 400. A third terminal of the electronic switch Q2 is grounded.

In at least one embodiment, a resistance of the resistor R1 is equal to a resistance of the resistor R4, and a resistance of the resistor R5 is equal to a resistance of the resistor R8. A resistance of the resistor R3 is slightly greater than a resistance of the resistor R2, and a resistance of the resistor R7 is slightly greater than a resistance of the resistor R6. The resistors R3 and R7 are negative temperature coefficient thermistors where the resistance of the resistors R3 and R7 decreases as the temperature around the resistors R3 and R7 increases. The resistor R3 is located in close proximity to field effect transistors (FETs) of the first power circuit 200. The resistor R7 is located close to FETs of the second power circuit 300.

In operation, when the power supply circuit 500 operates, a first voltage divided by the resistors R1 and R2 for input to the non-inverting input terminal of the comparator U1 is less than a second voltage divided by the resistors R3 and R4 for input to the inverting input terminal of the comparator U1. The comparator U1 outputs a low-level signal, such as logic 0, to turn off the electronic switch Q1. At the same time, a third voltage divided by the resistors R5 and R6 for input to the non-inverting input terminal of the comparator U2 is less than a fourth voltage divided by the resistors R7 and R8 for input to the inverting input terminal of the comparator U2. The comparator U2 then outputs a low-level signal to turn off the electronic switch Q2. The enable terminal En of the PWM controller 400 receives an Enable signal from the motherboard 1 and the power supply circuit 500 operates normally.

When a current of the first power circuit 200 is increased, temperatures of the FETs of the first power circuit 200 correspondingly increase. Resistance of the resistor R3 which is near the FETs goes down. When the temperatures of the FETs of the first power circuit 200 increases to a certain degree, resistance of the resistor R3 is less than resistance of the resistor R2. The first voltage of the non-inverting input terminal of the comparator U1 is then greater than the second voltage of the inverting input terminal of the comparator U1. The comparator U1 outputs a high-level signal, such as logic 1, to turn on the electronic switch Q1. The enable terminal En of the PWM controller 400 receives the low-level signal and stops operation of the PWM controller 400, thereby protecting the FETs of the first power circuit 200.

When a current of the second power circuit 300 is increased, temperatures of the FETs of the second power circuit 300 also increase. Resistance of the resistor R7 which is near the FETs goes down. When the temperatures of the FETs of the second power circuit 300 increases to a certain degree, resistance of the resistor R7 is less than resistance of the resistor R6. The third voltage of the non-inverting input terminal of the comparator U2 is greater than the fourth voltage of the inverting input terminal of the comparator U2. The comparator U2 then outputs a high-level signal to turn on the electronic switch Q2. The enable terminal En of the PWM controller 400 receives the low-level signal and stops operation of the PWM controller 400, thereby protecting the FETs of the second power circuit 300.

In at least one embodiment, each of the electronic switches Q1 and Q2 can be an n-channel FET, and the first terminal, the second terminal, and the third terminal of each of the electronic switches Q1 and Q2 can be a gate, a source, and a drain of the FET respectively. In at least one embodiment, each of the electronic switches Q1 and Q2 may be an npn bipolar junction transistor (BJT), and each of the electronic switches Q1 and Q2 may be another switch having similar functions.

Even though numerous characteristics and advantages of the disclosure have been set forth in the foregoing description, together with details of the structure and function of the disclosure, the disclosure is illustrative only, and changes may be made in detail, including the matters of shape, size, and arrangement of parts within the principles of the disclosure to the full extent indicated by the broad general meaning of the terms in which the appended claims are expressed.

What is claimed is:

1. A over-current protection circuit connected to an enable terminal of a pulse width modulation (PWM) controller of a power supply circuit on a motherboard, for protecting field effect transistors (FETs) of a first power circuit of the power supply circuit, the over-current protection circuit comprising:
a first protection circuit comprising:
a first resistor, a second resistor, a third resistor, and a fourth resistor, wherein the third resistor is located in the vicinity of the FETs of the first power circuit, and wherein the third resistor is a negative temperature coefficient thermistor;
a comparator comprising a non-inverting input terminal connected to a power source through the first resistor and connected to a ground through the second resistor, an inverting input terminal connected to the power source through the fourth resistor and connected to a ground through the third resistor, and an output terminal; and
a first electronic switch comprising a first terminal connected to the output terminal of the comparator, a second terminal connected to the enable terminal of the PWM controller, and a third terminal coupled to a ground, wherein the second terminal of the first electronic switch is connected to the third terminal of the first electronic switch, in response to the first terminal of the first electronic switch receiving a high-level signal, wherein the second terminal of the first electronic switch is disconnected from the third terminal of the first electronic switch, in response to the first terminal of the first electronic switch receiving a low-level signal.

2. The over-current protection circuit of claim 1, wherein resistance of the first resistor is equal to resistance of the fourth resistor, resistance of the second resistor is less than resistance of the third resistor.

3. The over-current protection circuit of claim 1, wherein the first electronic switch is an n-channel field effect transistor (FET), the first, second, and third terminals of the first electronic switch are a gate, a drain, and a source of the FET, respectively.
